(19) United States
(12) Patent Application Publication
(10) Pub. No.: US 2026/0054383 A1
(43) Pub. Date: Feb. 26, 2026

(54) APPARATUS AND METHOD FOR CONVERTING PARAMETER OF MULTIPLE-JOINT ROBOT

(71) Applicant: KOREA INSTITUTE OF ROBOT & CONVERGENCE, Pohang-si (KR)

(72) Inventors: Byeong Gi YU, Pohang-si (KR); Mu Rim KIM, Pohang-si (KR); Jun Young LEE, Pohang-si (KR); Sang Hyun PARK, Pohang-si (KR)

(21) Appl. No.: 19/036,233

(22) Filed: Jan. 24, 2025

(30) Foreign Application Priority Data
Aug. 26, 2024 (KR) 10-2024-0114323

(51) Int. Cl. B25J 9/16

(52) U.S. Cl. CPC B25J 9/1653

(57) ABSTRACT

The present disclosure relates to an apparatus and method for converting a parameter of a multi-joint robot. The apparatus for converting a parameter of a multi-joint robot according to the present disclosure includes a parameter derivation unit configured to drive a unified robot description format (URDF) of an individual joint constituting the multi-joint robot, a coordinate calculation unit configured to calculate a coordinate system of the individual joint, and calculate a joint axis vector of the individual joint and a joint axis vector of a subsequent joint connected to the individual joint based on the coordinate system of the individual joint, and a parameter conversion unit configured to convert the URDF of the individual joint into a Denavit-Hartenberg (DH) parameter based on the joint axis vector of the individual joint and the joint axis vector of the subsequent joint.

### CROSS-REFERENCE TO RELATED APPLICATION

This present application claims the benefit of priority to Korean Patent Application No. 10-2024-0114323, entitled “Apparatus and method for converting parameters of a robot” filed on Aug. 26, 2024, in the Korean Intellectual Property Office, the entire disclosure of which is incorporated herein by reference.

### FIELD

The present disclosure relates to an apparatus and method for converting a parameter of a multi-joint robot, and more particularly, to an apparatus and method for converting a parameter of a multi-joint robot by using joint axes of the multi-joint robot.

### BACKGROUND

A robot basically includes a joint and a link that connect the joints.

Therefore, for robot control, a method is needed to express the relative positions and orientations of joints and links required for kinematics and dynamics calculations.

For this purpose, previously, a method of describing a robot using a Denavit-Hartenberg (DH) parameter including four parameters has been mainly used.

However, since the DH parameter requires the use of a z-axis that takes into account a rotation direction of the joint in addition to the four parameters, and a separate coordinate system should be assigned according to the conditions that take this into account, there is a disadvantage in that it is difficult for users without specialized knowledge to describe robots using the DH parameter.

Accordingly, recently, a method called a Unified Robot Description Format (URDF), which solves the complex calculation problem of the above-described DH parameter and describes information on robot joints and links by using six parameters x, y, z, R, P, and Y and a three-dimensional vector rotation axis that may have an arbitrary direction, is also being widely used.

However, since there is an advantage in that various kinematic applications and existing solutions may be utilized when describing the robot using the DH parameter, such as robot systems, calibration algorithms, and inverse kinematics algorithms, the DH parameter is still being utilized in the field.

Therefore, it is important to convert the parameter into an appropriate parameter for the situation and use the appropriate parameter for calculation, rather than describing the robot using only one of the DH parameters or URDF.

However, in the case of the related art, although it is possible to convert the DH parameter into the URDF, there is no technology to convert the URDF into the DH parameter without specific conditions, so there is a problem in that the robot could not be described using the DH parameter in a situation where only URDF information is available and specific conditions are not satisfied.

In addition, in the case of the related art, when the DH parameter is converted into the URDF satisfying specific conditions, there is also a problem in that the coordinate system, mass tensor, visual information, and collision information originally described in the URDF may not be utilized.

### SUMMARY

The present disclosure has been made to solve the problems described above, and an object of the present disclosure is to provide an apparatus and method for converting a parameter of a multi-joint robot, which may convert a Unified Robot Description Format (URDF) into a Denavit-Hartenberg (DH) parameter in a general situation without specific conditions.

Another object of the present disclosure is to provide an apparatus and method for converting a parameter of a multi-joint robot, which may also be utilized when converting information such as mass tensor and visual information described in the URDF into the DH parameter.

Objects of the present disclosure are not limited to the above-mentioned object, and other objects and advantages of the present disclosure, which are not mentioned, will be understood through the following description, and will become apparent from embodiments of the present disclosure. It is also to be understood that the objects and advantages of the present disclosure may be realized by means and combinations thereof set forth in claims.

For the above purpose, an apparatus for converting a parameter of a multi-joint robot according to one embodiment of the present disclosure includes: a parameter derivation unit configured to derive a unified robot description format (URDF) of an individual joint constituting the multi-joint robot; a coordinate calculation unit configured to calculate a coordinate system of the individual joint, and calculate a joint axis vector of the individual joint and a joint axis vector of a subsequent joint connected to the individual joint based on the coordinate system of the individual joint; and a parameter conversion unit configured to convert the URDF of the individual joint into a Denavit-Hartenberg (DH) parameter based on the joint axis vector of the individual joint and the joint axis vector of the subsequent joint.

Moreover, a method for converting a parameter of a multi-joint robot according to one embodiment of the present disclosure includes: deriving a unified robot description format (URDF) of an individual joint constituting the multi-joint robot; calculating a coordinate system of the individual joint, and calculating a joint axis vector of the individual joint and a joint axis vector of a subsequent joint connected to the individual joint based on the coordinate system of the individual joint; and converting the URDF of the individual joint into a Denavit-Hartenberg (DH) parameter based on the joint axis vector of the individual joint and the joint axis vector of the subsequent joint.

According to the present disclosure, it is possible convert the URDF into the DH parameter in general situations even if specific conditions are not satisfied.

Moreover, according to the present disclosure, it is possible to use information such as mass tensor and visual information described in the URDF in the DH parameter.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a block diagram of an apparatus for converting a parameter of a multi-joint robot according to one embodiment of the present disclosure.

FIG. 2 is a flowchart of a method for converting a parameter of a multi-joint robot according to one embodiment of the present disclosure.

FIG. 3 is a diagram illustrating how to calculate a reference coordinate system in the case of an initial joint according to one embodiment of the present disclosure.

FIG. 4 is a diagram illustrating how to calculate the coordinate system of a joint when the joint is not an initial joint according to one embodiment of the present disclosure.

FIG. 5 is a diagram illustrating a parameter conversion unit according to one embodiment of the present disclosure converting a URDF into a DH parameter by using a straight line perpendicular to two joint axis vectors of a skewed position.

FIG. 6 is a diagram illustrating the parameter conversion unit according to one embodiment of the present disclosure converting the URDF into the DH parameter by using two joint axis vectors in a parallel relationship and an arbitrary straight line.

FIG. 7 is a diagram illustrating the parameter conversion unit according to one embodiment of the present disclosure converting the URDF into the DH parameter by using two joint axis vectors that are coincidence and have the same direction.

FIG. 8 is a diagram illustrating the parameter conversion unit according to one embodiment of the present disclosure converting the URDF into the DH parameter by using two joint axis vectors that are coincidence and have opposite directions.

FIG. 9 is a diagram illustrating the parameter conversion unit according to one embodiment of the present disclosure converting the URDF into the DH parameter by using the point of contact of two joint axis vectors in an intersection relationship.

### DETAILED DESCRIPTION

Hereinafter, reference will be made in detail to exemplary embodiments of the present disclosure, examples of which are illustrated in the accompanying drawings and described below, and wherever possible, the same or similar elements will be denoted by the same reference numerals even though they are depicted in different drawings and a redundant description thereof will thus be omitted. In the following description of the embodiments, suffixes, such as “module”, and “part”, are provided or used interchangeably merely in consideration of ease in statement of the specification, and do not have meanings or functions distinguished from one another. In the following description of the embodiments of the present disclosure, a detailed description of known functions and configurations incorporated herein will be omitted when it may make the subject matter of the present disclosure rather unclear. Further, the accompanying drawings will be exemplarily given to describe the embodiments of the present disclosure, and should not be construed as being limited to the embodiments set forth herein, and it will be understood that the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

First, to elaborate on the DH parameter and URDF mentioned above, the four parameters constituting the DH parameter are θ (Theta) representing a rotation angle of a robot joint, d (distance) representing the distance between two joints, a (link length) representing a length of a previous link, and twist angle α (skew angle) representing the angle between the previous link and the current link.

In addition, the DH parameter representation method uses a z-axis joint for four parameters to represent the relationship between two coordinate systems, that is, the reference coordinate system (world frame) of the reference joint and the coordinate system of the subsequent joint following the reference joint.

In this way, the DH parameter has the advantage of being able to describe the robot simply because they may define six degrees of freedom representing the movement of an object in three-dimensional space using four parameters.

Additionally, using the DH parameter has the advantage of being able to describe most robots.

However, since the DH parameter may only describe a robot in a situation where two constraints, called DH conditions, are satisfied: the z-axis of the previous joint intersects and is perpendicular to the x-axis of the current joint, a limited coordinate system must be assigned, and in certain situations, the use of the DH parameter may require placing a coordinate system outside the robot, which may lead to unintuitive computations.

Meanwhile, in the case of URDF, since there are no restrictions on specifying the coordinate system of the link or setting the direction of the joint axis, even users without specialized knowledge in robotics may describe the robot expressed in URDF simply by specifying the coordinate system at the location where they want to know the kinematic characteristics of the robot and specifying the joint type and axis direction.

However, the URDF has a shortcoming in that it lacks data such as kinematics and dynamics libraries compared to the DH parameter, so depending on the situation, it may be necessary to utilize data such as kinematics and dynamics libraries using the DH parameter rather than the URDF.

Accordingly, in one embodiment of the present disclosure, an apparatus and method for converting the URDF into the DH parameter are proposed by using four parameters, which are the minimum DH parameters capable of expressing between two coordinate systems.

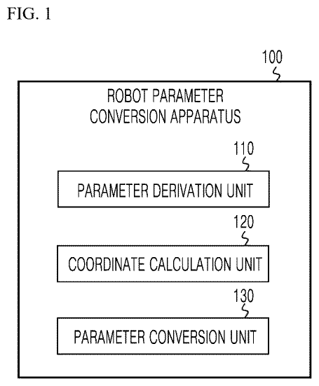

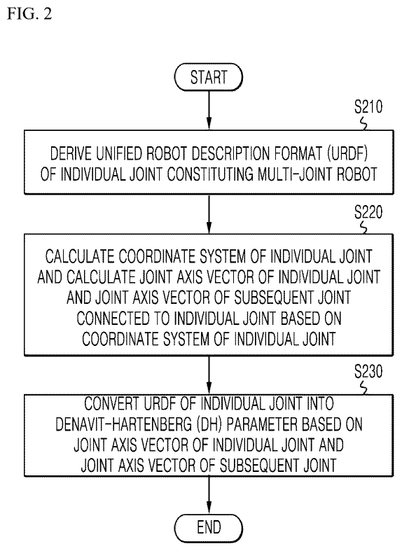

Hereinafter, an apparatus and method for converting a parameter of a multi-joint robot according to the present disclosure will be described in detail with reference to FIGS. 1 and 2.

FIG. 1 is a block diagram of an apparatus for converting a parameter of a multi-joint robot according to one embodiment of the present disclosure, and FIG. 2 is a flowchart of a method for converting a parameter of a multi-joint robot according to one embodiment of the present disclosure.

Referring to FIG. 1, a robot parameter conversion apparatus 100 includes a parameter derivation unit 110, a coordinate calculation unit 120, a parameter conversion unit 130, or the like.

The parameter derivation unit 110 derives a Unified Robot Description Format (URDF) of an individual joint constituting a multi-joint robot (see step S210).

For example, the URDF is information including six parameters x, y, z, R, P and Y, a central mass value, and a mass tensor that represent the correlation between two coordinate Systems.

Therefore, the parameter derivation unit 110 analyzes the correlation of an individual joint that constitutes the robot, a subsequent joint connected to the individual joint, and a link to derive the URDF that describes the robot.

The coordinate calculation unit 120 calculates a coordinate system of the individual joint, and based on the coordinate system of the individual joint, generates a joint axis of the individual joint and a joint axis of the subsequent joint connected to the individual joint (see step S220).

More specifically, the coordinate calculation unit 120 may calculate the coordinate system of the individual joint, the joint axis, and the joint axis of the subsequent joint by [Expression 1] described below.

$${j}_{0} = {z}_{0 \_ new} = {z}_{0} \qquad [ Expression 1 ]$$

$${o}_{0 \_ new} = {o}_{0}$$

$${x}_{0 \_ new} = {x}_{0}$$

(here, j₀ is a joint axis vector in a reference coordinate system of an initial joint, z_{0_new} is a z-axis unit vector of a joint in a {new} coordinate system of the initial joint, z₀ is a z-axis vector of a joint in the reference coordinate system of the initial joint, o_{0_new} is an origin value in the {new} coordinate system of the initial joint, o₀ is an origin value in the reference coordinate system of the initial joint, x_{0_new} is an x-axis unit vector in the {new} coordinate system of the initial joint, and x₀ is an x-axis unit vector in the reference coordinate system of the initial joint)

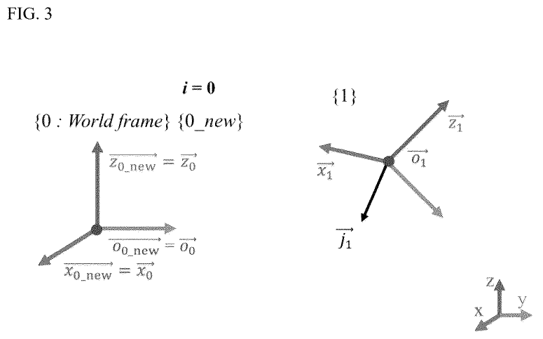

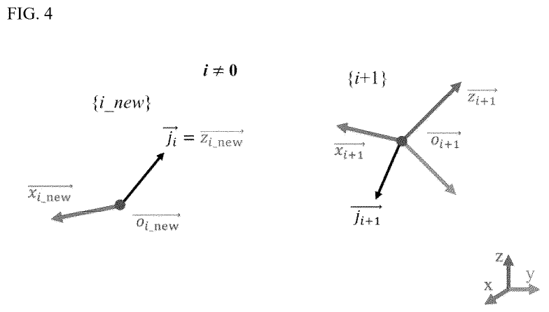

In this regard, FIG. 3 is a diagram illustrating how to calculate the reference coordinate system in a case where the joint is the initial joint according to one embodiment of the present disclosure, and FIG. 4 is a diagram illustrating how to calculate a coordinate system of a corresponding joint in a case where the joint is not the initial joint according to one embodiment of the present disclosure.

Referring to FIG. 3, when the value of i is 0, this indicates the initial joint, and the coordinate calculation unit 120 may calculate unit vectors and an origin of each of x, y, and z of the reference coordinate system as in [Expression 1] described above by referring to the x-axis, y-axis, and z-axis of the initial joint.

When the reference coordinate system of the initial joint is calculated, the coordinate calculation unit 120 may calculate the coordinate system of a first joint, which is the subsequent joint of the initial joint, and calculate a joint axis vector j₁.

Additionally, the coordinate calculation unit 120 assigns D₀ as a zero vector and R_{d0} as an identity matrix.

For reference, Do represents a difference between origin position vectors of the two coordinate systems, and Rat is a relative value of the {i} coordinate system of the i-th joint with respect to {0} which is the coordinate system of the initial joint.

Referring to FIG. 4, when the value of i is not 0, the coordinate calculation unit 120 may not use the coordinate system of the initial joint to calculate the coordinate system of the i-th joint. However, the coordinate calculation unit 120 may calculate the joint axis unit vector jᵢ by using the x-axis, y-axis, and y-axis unit vectors of the existing URDF.

Next, referring to FIG. 1, the parameter conversion unit 130 converts the URDF of the individual joint into a Denavit-Hartenberg (DH) parameter based on the joint axis unit vector of the individual joint and the joint axis unit vector of the subsequent joint (see step S230).

For example, the joint axis unit vector jᵢ of the i-th joint, which is the individual joint, and the joint axis unit vector jᵢ₊₁ of the i+1-th joint, which is the subsequent joint, may be defined in four correlations according to the positional relationship of the unit vectors.

Accordingly, the parameter conversion unit 130 analyzes the correlation between the joint axis unit vector of the individual joint and the joint axis unit vector of the subsequent joint.

Here, the aforementioned correlation is a relationship that represents one of skew, parallel, coincidence, and intersecting.

Below, the method by which the parameter conversion unit 130 converts the URDF into the DH parameter according to the positional relationship between the joint axis vector of the aforementioned individual joint and the joint axis vector of the subsequent joint will be described.

First, among the aforementioned correlations, the skew is the most general case, which is when the joint axis vectors jᵢ and jᵢ₊₁ are neither parallel nor intersecting, and there exists a unique straight line that is simultaneously perpendicular to both vectors.

Here, since the unique straight line is a straight line that satisfies the axes that intersect and are perpendicular to the aforementioned DH conditions, when the unique straight line is used, the URDF may be converted into the DH parameter.

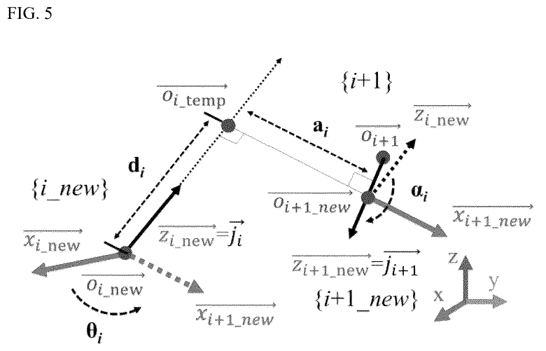

In this regard, FIG. 5 is a diagram illustrating a parameter conversion unit according to one embodiment of the present disclosure converting the URDF into the DH parameter by using a straight line that is perpendicular to two joint axis vectors of a skewed position.

Referring to FIG. 5, the parameter conversion unit 130 sets the i+1th joint axis vector jᵢ₊₁ to z_{i+1_new}, and calculates the joint axis vectors created by z_{i_new} and z_{i+1_new}, and position vectors o_{i_temp} and o_{i+1_new} of the point of contact of the straight line perpendicular to the two joint axis vectors.

To this end, the equation of the two straight lines created by z_{i_new} and z_{i+1_new} may be expressed in Expression as follows.

$${z}_{i + 1 \_ new} = {j}_{i + 1} \qquad [ Expression 2 ]$$

$${r}_{1} = {λ}_{a} {z}_{i \_ new} + {o}_{i \_ new}$$

$${r}_{2} = {λ}_{b} {z}_{i + 1 \_ new} + {o}_{i + 1}$$

(Here, z_{i+1_new} is a z-axis vector of the i+1th joint, jᵢ₊₁ is a joint axis vector of the i+1th joint, r₁ is an equation of a straight line created by the z_{i_new}, r₂ is an equation of a straight line created by the z_{i+1_new}, o_{i_new} is a position vector of a point of contact of a straight line perpendicular to the z_{i_new}, oᵢ₊₁ is a position vector of a point of contact of a straight line perpendicular to the z_{i+1_new}, and λ₁ and λ₂ are the slopes of the straight lines)

Therefore, by using [Expression 2], an expression for the points oₜₑₘₚ and o_{i+1_new} that meet perpendicularly to the two straight lines is organized, it may be expressed as the following Expression.

$${o}_{i \_ temp} = {λ}_{1} {z}_{i \_ new} + {o}_{i \_ new} \qquad [ Expression 3 ]$$

$${o}_{i + 1 \_ new} = {λ}_{2} {z}_{i + 1 \_ new} + {o}_{i + 1}$$

(here, λ₁ and λ₂ are the slopes of the straight lines)

Accordingly, an equation of the straight line that perpendicularly meets two straight lines may be expressed as an expression as follows.

$${r}_{3} = {o}_{i + 1 \_ new} - {o}_{{i}_{temp}} = {λ}_{2} {z}_{i + {1}_{new}} + {o}_{i + 1} - ( {λ}_{1} {z}_{{i}_{new}} + {o}_{i \_ new} ) \qquad [ Expression 4 ]$$

(Here, r₃ is the equation of the straight line that perpendicularly meets the joint axis vector)

Here, when r₃ is normalized for the convenience of the calculation, it may be expressed as x_{i+1_new}=r₃/∥r₃∥.

Next, in order to obtain the values of the o_{i_temp}, o_{i+1_new}, and x_{i+1_new}, it is necessary to calculate the slopes λ₁ and λ₂ of the aforementioned straight lines. This may be expressed in an expression as follows.

$$\begin{matrix}[ \begin{matrix}{λ}_{1} \\ {λ}_{2}\end{matrix} ] = {[ \begin{matrix}- {‖ {z}_{i \_ new} ‖}^{2} & {z}_{i \_ new} \cdot {z}_{i + 1 \_ new} \\ - {z}_{i \_ new} \cdot {z}_{i + 1 \_ new} & - {‖ {z}_{i + 1 \_ new} ‖}^{2}\end{matrix} ]}^{- 1} [ \begin{matrix}- ( {o}_{i + 1} - {o}_{i \_ new} ) \cdot {z}_{i \_ new} \\ - ( {o}_{i + 1} - {o}_{i \_ new} ) \cdot {z}_{i + 1 \_ new}\end{matrix} ] \\ = {[ \begin{matrix}- 1 & {z}_{i \_ new} \cdot {z}_{i + 1 \_ new} \\ - {z}_{i \_ new} \cdot {z}_{i + 1 \_ new} & 1\end{matrix} ]}^{- 1} [ \begin{matrix}- ( {o}_{i + 1} - {o}_{i \_ new} ) \cdot {z}_{i \_ new} \\ - ( {o}_{i + 1} - {o}_{i \_ new} ) \cdot {z}_{i + 1 \_ new}\end{matrix} ]\end{matrix} \qquad [ Expression 5 ]$$

Finally, by using the aforementioned [Expression 4] and [Expression 5], it is possible to convert the URDF into the DH parameter that satisfies the DH conditions. This may be expressed in an expression as follows.

$${α}_{i} = ( {o}_{i + 1 \_ new} - {o}_{i \_ new} ) \cdot {x}_{i + 1 \_ new} \qquad [ Expression 6 ]$$

$$cos {α}_{i} = {z}_{i \_ new} \cdot {z}_{i + 1 \_ new}$$

$$sin {α}_{i} = ( {z}_{i \_ new} \times {z}_{i + 1 \_ new} ) \cdot {x}_{i + 1 \_ new}$$

$${d}_{i} = ( {o}_{i + 1 \_ new} - {o}_{i \_ new} ) \cdot {z}_{i \_ new}$$

$$cos {θ}_{i} = {x}_{i \_ new} \cdot {x}_{i + 1 \_ new}$$

$$sin {θ}_{i} = ( {x}_{i \_ new} \times {x}_{i + 1 \_ new} ) \cdot {z}_{i \_ new}$$

(Here, αᵢ is a length of a previous link at the i-th joint, cos at is a cosine value of a skew angle α of the i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

Next, referring to FIG. 1, the parameter conversion unit 130 may consider a parallel relationship among the aforementioned correlations. In the parallel relationship, there is not only one common normal line that uniquely connects two joint axis vectors, so there are innumerable solutions. Therefore, it is necessary to designate an arbitrary specific straight line.

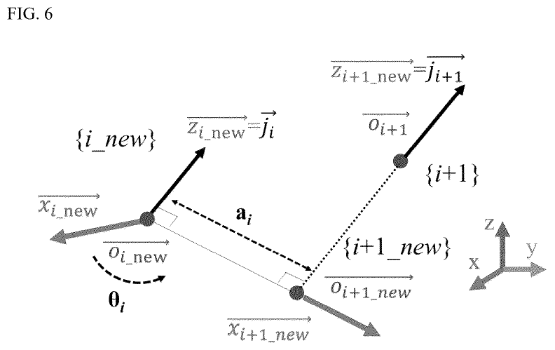

In this regard, FIG. 6 is a diagram illustrating the parameter conversion unit according to one embodiment of the present disclosure converting the URDF into the DH parameter by using two joint axis vectors in a parallel relationship and an arbitrary straight line.

Referring to FIG. 6, when the parameter conversion unit 130 designates a straight line passing through the origin o_{i_new} as an arbitrary straight line, the value of dᵢ may be derived as 0.

Additionally, since the two joint axis vectors z_{i+1_new} and z_{i_new} are parallel to each other, the value of the skew angle α may also be derived as 0.

Accordingly, the parameter conversion unit 130 needs to derive the o_{i+1_new} and x_{i+1_new} in order to convert the URDF into the DH parameter using the aforementioned [Expression 6], which may be expressed in the following Expression.

$${o}_{i + 1 \_ new} = {o}_{i + 1} - ( ( {o}_{i + 1} - {o}_{i \_ new} ) \cdot {z}_{i + 1 \_ new} ) {z}_{i + 1 \_ new} \qquad [ Expression 7 ]$$

$${x}_{i + 1 \_ new} = ( {o}_{i + 1 \_ new} - {o}_{i \_ new} ) / ‖ {o}_{i + 1 \_ new} - {o}_{i \_ new} ‖$$

Then, the parameter conversion unit 130 converts the URDF into the DH parameter by substituting the derived o_{i+1_new} and x_{i+1_new} into the aforementioned [Expression 6].

Next, referring to FIG. 1, the parameter conversion unit 130 may consider the coincidence relationship among the aforementioned correlations.

Accordingly, the parameter conversion unit 130 sets the values of the variables as o_{i+1_new}=o_{i_new} and x_{i+1_new}=x_{i_new} by considering the coincidence relationship.

In the coincidence relationship, two joint axis vectors are on the same straight line. Depending on the direction of the two joint axis vectors, a case in which the two joint axis vectors are in the same direction (a) or the case in which the two joint axis vectors are in opposite directions (b) may be considered.

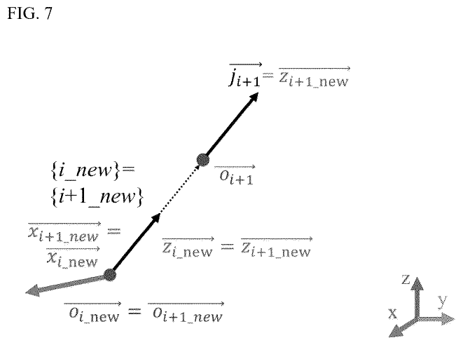

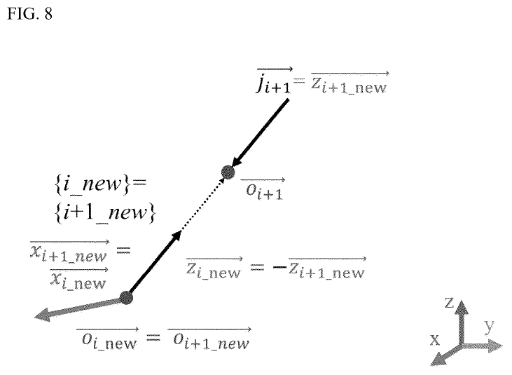

In this regard, FIG. 7 is a diagram illustrating the parameter conversion unit according to one embodiment of the present disclosure converting the URDF into the DH parameter by using two joint axis vectors that are coincidence and have the same direction, and FIG. 8 is a diagram illustrating the parameter conversion unit according to one embodiment of the present disclosure converting the URDF into the DH parameter by using two joint axis vectors that are coincidence and have opposite directions.

Referring to FIG. 7, two joint axis vectors having the same direction may derive the DH parameters by using the aforementioned [Expression 6] without deriving additional values. However, all DH parameters, such as the distance between the robot joint and link and the skew angle, are derived as 0.

Referring to FIG. 8, the DH parameter may also be derived by using the aforementioned [Expression 6] without deriving additional values for two joint axis vectors with opposite directions. However, among the parameters of the DH parameters, the skew angle αᵢ is fixed to π.

Next, referring to FIG. 1, the parameter conversion unit 130 may consider the intersection relationship among the aforementioned correlations.

When the two joint axis vectors Z_{i+1_new} and Z_{i_new} intersect, the point of contact of the two joint axis vectors is determined, so the parameter conversion unit 130 may derive the new {i+1_new} coordinate system from the point of contact and convert the URDF into the DH parameter.

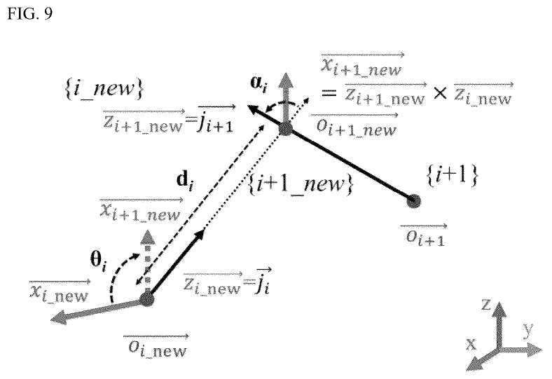

In this regard, FIG. 9 is a diagram illustrating the parameter conversion unit according to one embodiment of the present disclosure converting the URDF into the DH parameter by using the point of contact of two joint axis vectors in an intersection relationship.

Accordingly, in order to use the aforementioned [Expression 6], the o_{i+1_new} and x_{i+1_new} are expressed as an expression as follows.

$${x}_{i + 1 \_ new} = {z}_{i + 1 \_ new} \times {z}_{i \_ new} \qquad [ Expression 8 ]$$

$${r}_{1} = {λ}_{a} {z}_{i \_ new} + {o}_{i \_ new}$$

$${r}_{2} = {λ}_{b} {z}_{i + 1 \_ new} + {o}_{i + 1}$$

$${λ}_{a} = \frac{( {o}_{i \_ new} + {o}_{i + 1} ) \times {z}_{i + 1 \_ new} \cdot ( {z}_{i \_ new} \times {z}_{i + 1 \_ new} )}{( {z}_{i \_ new} \times {z}_{i + 1 \_ new} ) \cdot ( {z}_{i \_ new} \times {z}_{i + 1 \_ new} )}$$

$${o}_{i + 1 \_ new} = {λ}_{a} {z}_{i \_ new} + {o}_{i \_ new}$$

Finally, the parameter conversion unit 130 may convert into DH parameters using the aforementioned [Expression 6] and [Expression 8].

Next, referring to FIG. 1, in the process of [Expression 6] described above, the parameter conversion unit 130 performs the calculation by creating the {i_new} coordinate system instead of the {i} coordinate system of the URDF. Therefore, it is necessary to verify the relationship between the {i} coordinate system and {i_new}, and to convert the link mass center value and mass tensor of the URDF to fit the {i_new} coordinate system.

Accordingly, the parameter conversion unit 130 verifies the relationship between the {i} coordinate system and {i_new} by the following [Expression 9].

$${D}_{i + 1} = {o}_{i + 1} - {o}_{i + 1 \_ new} \qquad [ Expression 9 ]$$

$${R}_{d ( i + 1 )} = {R}_{i + 1 \_ new}^{T} {R}_{i + 1}$$

(Here, Dᵢ₊₁ is the difference between the two origin position vectors of the {i} coordinate system and the {i_new} coordinate system, R_{d(i+1)} is the correlation between the {i+1} and {i+1_new} coordinate systems, R_{i_new} is a relative value of the {i_new} coordinate system of the i-th joint to {0} which is the coordinate system of the initial joint, and R_{i+1_new} is a relative value of the {i+1} coordinate system of the i+1-th joint to {0} which is the coordinate system of the initial joint.)

Next, the parameter conversion unit 130 converts the link mass center value and the mass tensor among the URDF information of the individual joint into the DH parameter using the following [Expression 10].

$${COM}_{i\_new} = {R}_{di} {COM}_{i} + {R}_{i\_new}^{T} {D}_{i} \qquad [ Expression 10 ]$$

$${I}_{i\_new} = {R}_{di} {I}_{i} {R}_{di}^{T} + {m}_{i} [ ( {COM}_{i\_new} \cdot {COM}_{i\_new} ) {I}_{3} - ( {COM}_{i\_new} {COM}_{i\_new}^{T} ) ]$$

(Here, COM_{i_new} is the link mass center value in the {i_new} coordinate system, COMᵢ is the link mass center value in the {i} coordinate system, mᵢ is the mass of the link i, R_{di} is the correlation between the {i} coordinate system and the {i_new} coordinate system, R_{i_new} is a relative value of the {i_new} coordinate system of the i-th joint with respect to {0} which is the coordinate system of the initial joint, Dᵢ is a difference between two origin position vectors of the {i} coordinate system and the {i_new} coordinate system, I_{i_new} is a mass tensor of the {i_new} coordinate system, Iᵢ is a mass tensor of the {i} coordinate system, and I₃ is a 3×3 identity matrix)

In the specification (particularly, in the claims) of the present disclosure, use of the term “above” and similar referential terms may refer to both the singular and the plural. In addition, when a range is stated in the present disclosure, the statement includes the invention to which individual values within the range are applied (unless there is a statement to the contrary), and is the same as a statement of the individual values constituting the range in the detailed description of the invention.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described embodiments, and the scope of the appended claims described below as well as all scopes equivalent to or equivalently changed from the claims are within the scope of the spirit of the present disclosure.

1. An apparatus for converting a parameter of a multi-joint robot, the apparatus comprising:
a parameter derivation unit configured to derive a unified robot description format (URDF) of an individual joint constituting the multi-joint robot;
a coordinate calculation unit configured to calculate a coordinate system of the individual joint, and calculate a joint axis vector of the individual joint and a joint axis vector of a subsequent joint connected to the individual joint based on the coordinate system of the individual joint; and
a parameter conversion unit configured to convert the URDF of the individual joint into a Denavit-Hartenberg (DH) parameter based on the joint axis vector of the individual joint and the joint axis vector of the subsequent joint.

2. The apparatus of claim 1, wherein the coordinate calculation unit calculates the coordinate system and the joint axis vector of the individual joint, and the joint axis vector of the subsequent joint by the following [Expression 1].
$${j}_{0} = {z}_{0 \_ new} = {z}_{0} \qquad [ Expression 1 ]$$
$${o}_{0 \_ new} = {o}_{0}$$
$${x}_{0 \_ new} = {x}_{0}$$
(here, j₀ is a joint axis vector in a reference coordinate system of an initial joint, z_{0_new} is a z-axis unit vector of a joint in a {new} coordinate system of the initial joint, z₀ is a z-axis vector of a joint in the reference coordinate system of the initial joint, o_{0_new} is an origin value in the {new} coordinate system of the initial joint, o₀ is an origin value in the reference coordinate system of the initial joint, x_{0_new} is an x-axis vector in the {new} coordinate system of the initial joint, and x₀ is an x-axis vector in the reference coordinate system of the initial joint)

3. The apparatus of claim 1, wherein the parameter conversion unit analyzes a correlation between the joint axis vector of the individual joint and the joint axis vector of the subsequent joint, and the correlation is one of skew, parallel, coincidence, and intersecting.

4. The apparatus of claim 3, wherein when the correlation is the skew, the parameter conversion unit converts the URDF of the individual joint into the DH parameter using the following [Expression 2].
$${α}_{i} = ( {o}_{i + 1 \_ new} - {o}_{i \_ new} ) \cdot {x}_{i + 1 \_ new} \qquad [ Expression 2 ]$$
$$cos {α}_{i} = {z}_{i \_ new} \cdot {z}_{i + 1 \_ new}$$
$$sin {α}_{i} = ( {z}_{i \_ new} \times {z}_{i + 1 \_ new} ) \cdot {x}_{i + 1 \_ new}$$
$${d}_{i} = ( {o}_{i + 1 \_ new} - {o}_{i \_ new} ) \cdot {z}_{i \_ new}$$
$$cos {θ}_{i} = {x}_{i \_ new} \cdot {x}_{i + 1 \_ new}$$
$$sin {θ}_{i} = ( {x}_{i \_ new} \times {x}_{i + 1 \_ new} ) \cdot {z}_{i \_ new}$$
(here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, z_{i+1_new} is an x-axis vector in the {i+1_new} coordinate system, cos α₁ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

5. The apparatus of claim 3, wherein when the correlation is the parallel, the parameter conversion unit converts the URDF of the individual joint into the DH parameter using the following [Expression 3].
$${o}_{i + 1 \_ new} = {o}_{i + 1} - ( ( {o}_{i + 1} - {o}_{{i}_{new}} ) \cdot {z}_{i + 1 \_ new} ) {z}_{i + 1 \_ new} \qquad [ Expression 3 ]$$
$${x}_{i + 1 \_ new} = ( {o}_{i + 1 \_ new} - {o}_{i \_ new} ) / ‖ {o}_{i + 1 \_ new} - {o}_{i \_ new} ‖$$
$${α}_{i} = ( {o}_{i + 1 \_ new} - {o}_{i\_new} ) \cdot {x}_{i + 1 \_ new}$$
$$cos {α}_{i} = {z}_{i\_new} \cdot {z}_{i + 1 \_ new}$$
$$sin {α}_{i} = ( {z}_{i\_new} \times {z}_{i + 1 \_ new} ) \cdot {x}_{i + 1 \_ new}$$
$${d}_{i} = ( {o}_{i + 1 \_ new} - {o}_{i\_new} ) \cdot {z}_{i\_new}$$
$$cos {θ}_{i} = {x}_{i\_new} \cdot {x}_{i + 1 \_ new}$$
$$sin {θ}_{i} = ( {x}_{i\_new} \times {x}_{i + 1 \_ new} ) \cdot {z}_{i\_new}$$
(here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, x_{i+1_new} is an x-axis vector in the {i+1_new} coordinate system, cos α is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

6. The apparatus of claim 3, wherein when the correlation is coincidence and a direction of the joint axis vector of the individual joint and a direction of the joint axis vector of the subsequent joint are the same, the parameter conversion unit defines the converted DH parameter as a value of the following [Expression 4].
$${α}_{i} = 0 \qquad [ Expression 4 ]$$
$$cos {α}_{i} = 0$$
$$sin {α}_{i} = 0$$
$${d}_{i} = 0$$
$$cos {θ}_{i} = 0$$
$$sin {θ}_{i} = 0$$
(here, αᵢ is a length of a previous link at an i-th joint, cos αᵢ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

7. The apparatus of claim 3, wherein when the correlation is coincidence and a direction of the joint axis vector of the individual joint is opposite to a direction of the joint axis vector of the subsequent joint, the parameter conversion unit converts the URDF of the individual joint into the DH parameter using the following [Expression 5].
$${α}_{i} = ( {o}_{i + 1 \_ new} - {o}_{i\_new} ) \cdot {x}_{i + 1 \_ new} \qquad [ Expression 5 ]$$
$$cos {α}_{i} = - 1$$
$$sin {α}_{i} = 0$$
$${d}_{i} = ( {o}_{i + 1 \_ new} - {o}_{i\_new} ) \cdot {z}_{i\_new}$$
$$cos {θ}_{i} = {x}_{i\_new} \cdot {x}_{i + 1 \_ new}$$
$$sin {θ}_{i} = ( {x}_{i\_new} \times {x}_{i + 1 \_ new} ) \cdot {z}_{i\_new}$$
(Here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, x_{i+1_new} is an x-axis vector in the {i+1_new} coordinate system, cos αᵢ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

8. The apparatus of claim 3, wherein when the correlation is intersecting, the parameter conversion unit converts the URDF of the individual joint into the DH parameter using the following [Expression 6].
$${x}_{i + 1 \_ new} = {z}_{i + 1 \_ new} \times {z}_{i\_new} \qquad [ Expression 6 ]$$
$${r}_{1} = {λ}_{a} {z}_{i\_new} + {o}_{i\_new}$$
$${r}_{2} = {λ}_{b} {z}_{i + 1 \_ new} + {o}_{i + 1}$$
$${λ}_{a} = \frac{( {o}_{i \_ new} - {o}_{i + 1} ) \times {z}_{i + 1 \_ new} \cdot ( {z}_{i\_new} \times {z}_{i + 1 \_ new} )}{( {z}_{i \_ new} \times {z}_{i + 1 \_ new} ) \cdot ( {z}_{i\_new} \times {z}_{i + 1 \_ new} )}$$
$${o}_{i + 1 \_ new} = {λ}_{a} {z}_{i\_new} + {o}_{i\_new}$$
(Here, z_{i_new} is a z-axis vector in a {i_new} coordinate system, z_{i+1_new} is a z-axis vector in a {i+1_new} coordinate system, x_{i+1_new} is an x-axis vector in the {i+1_new} coordinate system, r₁ is an equation of a straight line created by the z_{i_new}, r₂ is an equation of a straight line created by the z_{i+1_new}, o_{i_new} is a position vector of a point of contact of a straight line perpendicular to the z_{i_new}, oᵢ₊₁ is a position vector of a point of contact of a straight line perpendicular to the z_{i+1_new}, and λ₁ and λ₂ are slopes of the straight lines)

9. The apparatus of claim 1, wherein the parameter conversion unit is converts the URDF of the individual joint into the DH parameter by the following [Expression 7].
$${COM}_{i\_new} = {R}_{di} {COM}_{i} + {R}_{i\_new}^{T} {D}_{i} \qquad [ Expression 7 ]$$
$${I}_{i\_new} = {R}_{di} {I}_{i} {R}_{di}^{T} + {m}_{i} [ ( {COM}_{i\_new} \cdot {COM}_{i\_new} ) {I}_{3} - ( {COM}_{i\_new} {COM}_{i\_new}^{T} ) ]$$
(Here, COM_{i_new} is a link mass center value in a {i_new} coordinate system, COMᵢ is a link mass center value in a {i} coordinate system, mi is a mass of link i, R_{di} is a correlation between the {i} coordinate system and the {i_new} coordinate system, R_{i_new} is a relative value of the {i_new} coordinate system of the i-th joint with respect to {0} which is a coordinate system of an initial joint, Dᵢ is a difference between two origin position vectors of the {i} coordinate system and the {i_new} coordinate system, I_{i_new} is a mass tensor of the {i_new} coordinate system, Iᵢ is a mass tensor of the {i} coordinate system, and I₃ is a 3×3 identity matrix)

10. A method for converting a parameter of a multi-joint robot, the method deriving a unified robot description format (URDF) of an individual joint constituting the multi-joint robot;
calculating a coordinate system of the individual joint, and calculating a joint axis vector of the individual joint and a joint axis vector of a subsequent joint connected to the individual joint based on the coordinate system of the individual joint; and
converting the URDF of the individual joint into a Denavit-Hartenberg (DH) parameter based on the joint axis vector of the individual joint and the joint axis vector of the subsequent joint.

11. The method of claim 10, wherein the calculating includes calculating the coordinate system and the joint axis vector of the individual joint, and the joint axis vector of the subsequent joint by the following [Expression 1].
$${j}_{0} = {z}_{0 \_ new} = {z}_{0} \qquad [ Expression 1 ]$$
$${o}_{0 \_ new} = {o}_{0}$$
$${x}_{0 \_ new} = {x}_{0}$$
(here, j₀ is a joint axis vector in a reference coordinate system of an initial joint, z_{0_new} is a z-axis unit vector of a joint in a {new} coordinate system of the initial joint, z₀ is a z-axis vector of a joint in the reference coordinate system of the initial joint, o_{0_new} is an origin value in the {new} coordinate system of the initial joint, o₀ is an origin value in the reference coordinate system of the initial joint, x_{0_new} is an x-axis vector in the {new} coordinate system of the initial joint, and x₀ is an x-axis vector in the reference coordinate system of the initial joint)

12. The method of claim 10, wherein the converting of the URDF into the DH parameter includes analyzing a correlation between the joint axis vector of the individual joint and the joint axis vector of the subsequent joint, and
the correlation is one of skew, parallel, coincidence, and intersecting.

13. The method of claim 12, wherein when the correlation is the skew, the converting of the URDF into the DH parameter includes converting the URDF of the individual joint into the DH parameter using the following [Expression 2].
$${α}_{i} = ( {o}_{i + 1 \_ new} - {o}_{i \_ new} ) \cdot {x}_{i + 1 \_ new} \qquad [ Expression 2 ]$$
$$cos {α}_{i} = {z}_{i \_ new} \cdot {z}_{i + 1 \_ new}$$
$$sin {α}_{i} = ( {z}_{i \_ new} \times {z}_{i + 1 \_ new} ) \cdot {x}_{i + 1 \_ new}$$
$${d}_{i} = ( {o}_{i + 1 \_ new} - {o}_{i \_ new} ) \cdot {z}_{i \_ new}$$
$$cos {θ}_{i} = {x}_{i \_ new} \cdot {x}_{i + 1 \_ new}$$
$$sin {θ}_{i} = ( {x}_{i \_ new} \times {x}_{i + 1 \_ new} ) \cdot {z}_{i \_ new}$$
(here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, z_{i+1_new} is an x-axis vector in the {i+1_new} coordinate system, cos αᵢ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

14. The method of claim 12, wherein when the correlation is the parallel, the converting of the URDF into the DH parameter includes converting the URDF of the individual joint into the DH parameter using the following [Expression 3].
$${o}_{i + 1 \_ new} = {o}_{i + 1} - ( ( {o}_{i + 1} - {o}_{{i}_{new}} ) \cdot {z}_{i + 1 \_ new} ) {z}_{i + 1 \_ new} \qquad [ Expression 3 ]$$
$${x}_{i + 1 \_ new} = ( {o}_{i + 1 \_ new} - {o}_{i \_ new} ) / ‖ {o}_{i + 1 \_ new} - {o}_{i \_ new} ‖$$
$${α}_{i} = ( {o}_{i + 1 \_ new} - {o}_{i\_new} ) \cdot {x}_{i + 1 \_ new}$$
$$cos {α}_{i} = {z}_{i\_new} \cdot {z}_{i + 1 \_ new}$$
$$sin {α}_{i} = ( {z}_{i\_new} \times {z}_{i + 1 \_ new} ) \cdot {x}_{i + 1 \_ new}$$
$${d}_{i} = ( {o}_{i + 1 \_ new} - {o}_{i\_new} ) \cdot {z}_{i\_new}$$
$$cos {θ}_{i} = {x}_{i\_new} \cdot {x}_{i + 1 \_ new}$$
$$sin {θ}_{i} = ( {x}_{i\_new} \times {x}_{i + 1 \_ new} ) \cdot {z}_{i\_new}$$
(here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, x_{i+1_new} is an x-axis vector in the {i+1_new} coordinate system, cos αᵢ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

15. The method of claim 12, wherein when the correlation is coincidence and a direction of the joint axis vector of the individual joint and a direction of the joint axis vector of the subsequent joint are the same, the converting of the URDF into the DH parameter includes defining the converted DH parameter as a value of the following [Expression 4].
$${α}_{i} = 0 \qquad [ Expression 4 ]$$
$$cos {α}_{i} = 0$$
$$sin {α}_{i} = 0$$
$${d}_{i} = 0$$
$$cos {θ}_{i} = 0$$
$$sin {θ}_{i} = 0$$
(here, αᵢ is a length of a previous link at an i-th joint, cos αᵢ is a cosine value of a skew angle α of an i-th joint axis, sin θᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

16. The method of claim 12, wherein the correlation is coincidence and a direction of the joint axis vector of the individual joint is opposite to a direction of the joint axis vector of the subsequent joint, the converting of the URDF into the DH parameter includes converting the URDF of the individual joint into the DH parameter using the following [Expression 5].
$${α}_{i} = ( {o}_{i + 1 \_ new} - {o}_{i\_new} ) \cdot {x}_{i + 1 \_ new} \qquad [ Expression 5 ]$$
$$cos {α}_{i} = - 1$$
$$sin {α}_{i} = 0$$
$${d}_{i} = ( {o}_{i + 1 \_ new} - {o}_{i\_new} ) \cdot {z}_{i\_new}$$
$$cos {θ}_{i} = {x}_{i\_new} \cdot {x}_{i + 1 \_ new}$$
$$sin {θ}_{i} = ( {x}_{i\_new} \times {x}_{i + 1 \_ new} ) \cdot {z}_{i\_new}$$
(Here, αᵢ is a length of a previous link at an i-th joint, z_{i_new} is a z-axis vector in a {i_new} coordinate system, z_{i+1_new} is a z-axis vector in a {i+1_new} coordinate system, o_{i+1_new} is a position vector of a point of contact of a straight line perpendicular to the z_{i+1_new}, o_{i_new} is a position vector of a point of contact of a straight line perpendicular to the z_{i_new}, x_{i+1_new} is an x-axis vector in the {i+1_new} coordinate system, cos αᵢ is a cosine value of a skew angle α of an i-th joint axis, sin αᵢ is a sine value of the skew angle α of the i-th joint axis, dᵢ is a distance of the i-th joint axis, cos θᵢ is a cosine value of a rotation angle θ of the i-th joint axis, and sin θᵢ is a sine value of the rotation angle θ of the i-th joint axis)

17. The method of claim 12, wherein when the correlation is intersecting, the converting of the URDF into the DH parameter includes conversting the URDF of the individual joint into the DH parameter using the following [Expression 6].
$${x}_{i + 1 \_ new} = {z}_{i + 1 \_ new} \times {z}_{i\_new} \qquad [ Expression 6 ]$$
$${r}_{1} = {λ}_{a} {z}_{i\_new} + {o}_{i\_new}$$
$${r}_{2} = {λ}_{b} {z}_{i + 1 \_ new} + {o}_{i + 1}$$
$${λ}_{a} = \frac{( {o}_{i \_ new} - {o}_{i + 1} ) \times {z}_{i + 1 \_ new} \cdot ( {z}_{i\_new} \times {z}_{i + 1 \_ new} )}{( {z}_{i \_ new} \times {z}_{i + 1 \_ new} ) \cdot ( {z}_{i\_new} \times {z}_{i + 1 \_ new} )}$$
$${o}_{i + 1 \_ new} = {λ}_{a} {z}_{i\_new} + {o}_{i\_new}$$
(Here, z_{i_new} is a z-axis vector in a {i_new} coordinate system, z_{i+1_new} is a z-axis vector in a {i+1_new} coordinate system, x_{i+1_new} is an x-axis vector in the {i+1_new} coordinate system, r₁ is an equation of a straight line created by the z_{i_new}, r₂ is an equation of a straight line created by the z_{i+1_new}, o_{i_new} is a position vector of a point of contact of a straight line perpendicular to the z_{i_new}, oᵢ₊₁ is a position vector of a point of contact of a straight line perpendicular to the z_{i+1_new}, and λ₁ and λ₂ are slopes of the straight lines.

18. The method of claim 10, wherein the converting of the URDF into the DH parameter includes converting the URDF of the individual joint into the DH parameter by the following [Expression 7].
$${COM}_{i\_new} = {R}_{di} {COM}_{i} + {R}_{i\_new}^{T} {D}_{i} \qquad [ Expression 7 ]$$
$${I}_{i\_new} = {R}_{di} {I}_{i} {R}_{di}^{T} + {m}_{i} [ ( {COM}_{i\_new} \cdot {COM}_{i\_new} ) {I}_{3} - ( {COM}_{i\_new} {COM}_{i\_new}^{T} ) ]$$
(Here, COM_{i_new} is a link mass center value in a {i_new} coordinate system, COMᵢ is a link mass center value in a {i} coordinate system, mᵢ is a mass of link i, R_{di} is a correlation between the {i} coordinate system and the {i_new} coordinate system, R_{i_new} is a relative value of the {i_new} coordinate system of the i-th joint with respect to {0} which is a coordinate system of an initial joint, Dᵢ is a difference between two origin position vectors of the {i} coordinate system and the {i_new} coordinate system, I_{i_new} is a mass tensor of the {i_new} coordinate system, Iᵢ is a mass tensor of the {i} coordinate system, and I₃ is a 3×3 identity matrix)
